(19) United States
(12) Patent Application Publication
(10) Pub. No.: US 2019/0286676 A1
(43) Pub. Date: Sep. 19, 2019

(54) CONTEXTUAL CONTENT COLLECTION, FILTERING, ENRICHMENT, CURATION AND DISTRIBUTION

(71) Applicant: Turbine Corporate Holdings, Inc., Greenwood Village, CO (US)

(72) Inventor: Leigh Fatzinger, Cherry Hills Village, CO (US)

(21) Appl. No.: 16/355,717

(22) Filed: Mar. 16, 2019

Related U.S. Application Data
(60) Provisional application No. 62/644,368, filed on Mar. 16, 2018.

(51) Int. Cl. G06F 16/9535; G06F 16/9538; G06F 16/9032; G06N 20/00; G06N 5/04; G06F 17/27

(52) U.S. Cl. CPC G06F 16/9535; G06F 16/9538; G06F 16/90332; G06F 17/2785; G06N 5/04; G06F 17/278; G06N 20/00

(57) ABSTRACT

A method and platform for internet content collection and the curation and delivery thereof comprises receiving, a natural language request about a topic; building a customized query about the topic; searching internet content sources for one or more content pieces responsive to the customized query; gathering the one or more content pieces into a query results data set; processing the one or more content pieces in the query results data set based on one or more attributes associated with the content pieces; ranking the content pieces based on one or more scoring algorithms; curating the content pieces by reviewing the content pieces for responsiveness to the natural language request; and creating a report comprising the content pieces for display in one or more specified report formats to report recipients.

### CROSS REFERENCE TO RELATED APPLICATIONS

The present application for patent claims priority to Provisional Application No. 62/644,368, entitled “CURATED MULTICAST CONTENT ROUTING” filed Mar. 16, 2018, and assigned to the assignee hereof and hereby expressly incorporated by reference herein.

### FIELD OF THE DISCLOSURE

The present disclosure relates generally to gathering, analyzing, curating, and distributing of data and content. In particular, but not by way of limitation, the present disclosure relates to systems, methods and apparatuses for finding information of interest within large amounts of online, print, broadcast, and digital data, evaluating it for relevance and other factors, and delivering it in a usable format to an end user.

### BACKGROUND

Many organizations, including governments, businesses, education institutions, and non-profits seek intelligence about their organizations from the internet in order to make informed decisions. Such intelligence may pertain to crises, brand awareness, public relations, customer service, news trends, data trends, and political events. For example, organizations may want to know how a new product is being received in the marketplace, or how a particular political event is likely to impact their organization. Many search tools, including well-known search engines, have made it theoretically possible for organizations to find such information about themselves or other entities and organizations. Organizations can use search engines to find top headlines and stories about such happenings. However, searching past such top results is time-consuming, and results beyond a first page of search engine returns often include irrelevant information.

To try to find more pertinent organizational intelligence, several automated types of technology have been developed in recent years. These technologies attempt to find relevant mentions of topics in news stories, press releases, blogs, and social media via web-crawling and scraping technology. Some of these technologies also incorporate “sentiment analysis,” which categorizes mentions as positive, neutral, or negative. Some services provide “clipping briefs,” which include links or extract portions of text from news articles and other media. However, there are several challenges with these existing technologies. For example, using such services often requires technical expertise such as constructing complex Boolean searches or writing code to find relevant results and filter out irrelevant ones. Sentiment analysis is often too unsophisticated to detect certain linguistic context clues. In addition, the Internet is ever-growing, and sheer volume and pace at which new content is added make it practically impossible for organizations to find as much timely, relevant information as they want. Therefore, a need exists to remedy these deficiencies.

### SUMMARY

An aspect of the present disclosure provides a method for internet content collection and the curation and delivery thereof. The method may comprise receiving, from a requester, a natural language request about a topic and building, based on the natural language request, a customized computer search logic query about the topic. The method may then comprise searching one or more internet content sources for one or more content pieces responsive to the customized computer search logic query, and gathering the one or more content pieces into a query results data set. The system may further comprise processing the one or more content pieces in the query results data set based on one or more tags associated with the content pieces, ranking the content pieces for relevance based on one or more scoring algorithms, curating the content pieces, and creating a report comprising the content pieces for display in one or more specified report formats to one or more report recipients.

Another aspect of the disclosure provides a platform for internet content collection and the curation and delivery thereof. The platform may be configured to receive, from a requester via a computing device, a natural language request about a topic and build, based on the natural language request, a customized computer search logic query about the topic. The platform may be further configured to run a search via a plurality of internet data and content sources for one or more content pieces responsive to the customized computer search logic query. Then the platform may gather the one or more content pieces into a query results data set in a database associated with the platform and process, via an application associated with the platform, the one or more content pieces in the query results data set based on one or more attributes associated with the content pieces. The platform may rank the content pieces for relevance based on one or more scoring algorithms, curate the content pieces, and create a report comprising the content pieces in one or more specified report formats to one or more report recipients for display on a graphical user interface remote from the platform.

### BRIEF DESCRIPTION OF THE DRAWINGS

FIG. 1 is a logical block diagram showing an overview of a system and method of the present disclosure;

FIG. 2 is a logical block diagram showing an intelligent customized query building system of the present disclosure;

FIG. 3 is logical block diagram showing a data processing and analysis system of the present disclosure;

FIG. 4 shows a high-level view of the system and an overview of different reporting formats of the present disclosure;

FIG. 5 shows an SMS-length alert reporting format of present disclosure;

FIG. 6 shows a short e-mail reporting format of the present disclosure;

FIG. 7 shows a first version of a long e-mail reporting format the present disclosure;

FIG. 8 shows a second version of a long e-mail reporting format of the present disclosure;

FIG. 9 is a logical block diagram of an embodiment of a platform architecture of the present disclosure;

FIG. 10 is logical block diagram of another embodiment of a platform architecture the present disclosure;

FIG. 11 is a flowchart depicting a method of the present disclosure;

FIG. 12 is a logical block diagram depicting a computer that may be used to implement one or more aspects of the present disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

An aspect of the present disclosure provides systems and methods for processing, enriching, curating and routing internet content and associated statistics and analysis to relevant human targets. For the purposes of the present disclosure, “content” may be used to refer to any sort of communication media available on the internet, including all or portions of news articles, blogs, videos, audio recordings, social media posts, press releases, surveys or survey results, graphics, or anything else that may be searchable on the internet. The disclosure may refer to various types of users. A “human target” or “requester” may be used to refer to a person making an inquiry or request of the system of the present disclosure. Other users of the system may include “report recipients” who may or may not be requesters themselves.

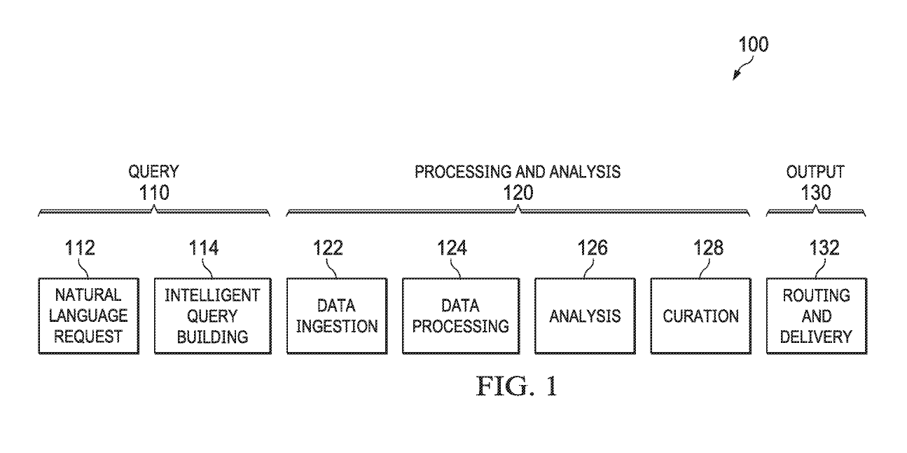

FIG. 1 shows an overview of a system that implements one or more methods of the present disclosure. Each aspect of the system will be described in further detail throughout the disclosure. A first portion of the system may comprise a query portion 110, which itself may comprise a natural language request portion 112 and an intelligent query building portion 114. At a processing and analysis portion 120, the system may comprise a data ingestion portion 112, a data processing portion 124, an analysis portion 126, and a curation portion 128. The next part of the system may be referred to as an “output” portion of the system 130. The output portion may comprise a routing and delivery component 132 that formats the output from the query portion 110 and the processing and analysis portion 120 and provides it in one of a plurality of delivery layouts, which vary in substance, specificity, and delivery method.

### Account Profiles

As a preliminary matter, to create some of the inputs added by the system, users (including requesters and/or report recipients) of the system may be set up with accounts which identify their organization and position within the organization. In embodiments, the system may require several elements from a user in order to begin a process of gathering content for the user. These elements may include a customer account name, a user name, a user title or persona, other information such as data from a social network profile, a phone number, and an office address. Other embodiments may require more or fewer elements from a user.

### Natural Language Request

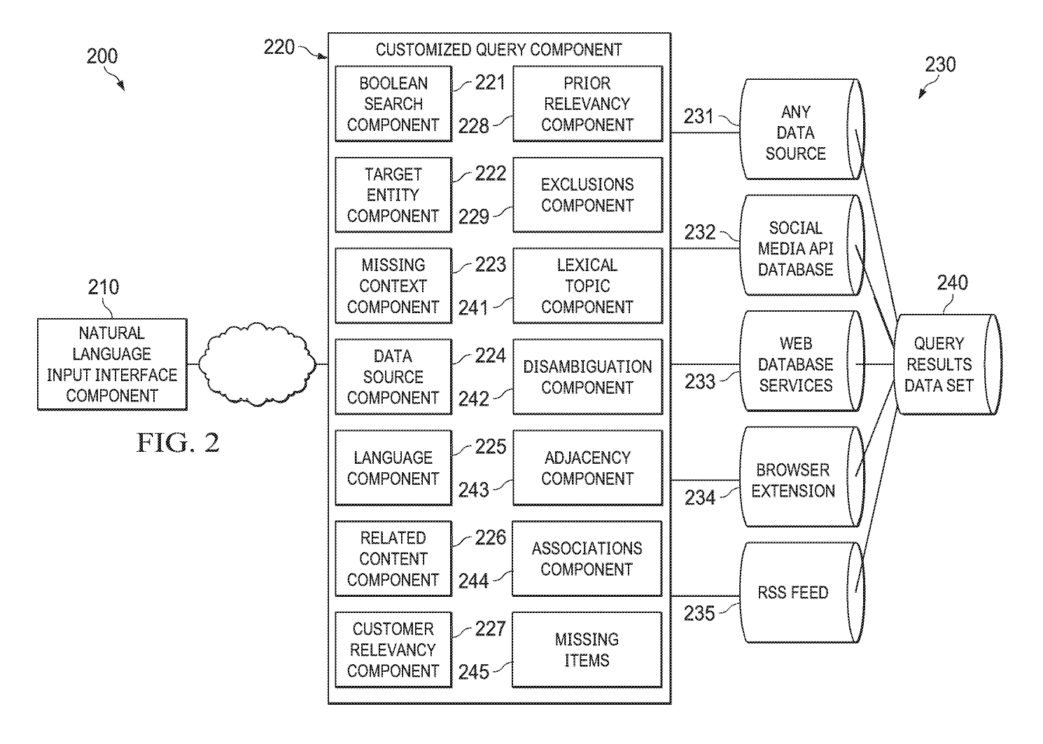

FIG. 2 depicts a first aspect of the system, which is the natural language request and intelligent customized query building system 200. The platform provides an interface 210 for a human user to enter a natural language request into the system for particular intelligence the person is seeking. “Intelligence” may be used to refer to any information that is relevant to a topic of interest, and may include not just content containing particular terms that a user may enter, but also content and information that relates to the query without directly referring to search terms. Examples of “relevant” or “related” intelligence that does not comprise exact search terms will be given later in this disclosure. A “natural language” query refers to a search term, topic, sentence fragment, question fragment, or full question written or spoken in ordinary words, as opposed to code, pseudo-code, or Boolean search terms. For example, a user may enter “how is our company's new product being received in the market?” A natural language request may be entered through a natural language input interface 210, which may be a text-fillable field on a computing device, an input via a voice-response computing device, other methods of accepting a human communication by a computing device, and automated natural language request generation inputs.

Text based search is how most modern search engines accept queries. A traditional search engine may pull up top news stories and listings of the new product for sale in response to this kind of query. Several limitations to this kind of search are immediately apparent; top stories only provide part of the story, and listings for the sale of the products are irrelevant. If the user wanted to get a broader sense of how the product was being received, the user could use a service that tracks mentions to comb the internet for the new product name. The user would have to think about what kinds of results to exclude; for example, the user would have to exclude results from online marketplaces such as eBay® and Amazon®, and mentions prior to a particular date. Additionally, the user would have to know how to write such a search excluding those results.

An aspect of the present disclosure is that the system transforms a natural language search request to minimize the amount of effort a user (also referred to herein as a requester) must expend to obtain the requested information, as well as to maximize the relevance of the eventual query output to the user. A natural language request may be entered through a natural language input interface, which may be a text-fillable field on a computing device or via a voice-response or voice-recognition-enabled computing device. In general, the system transforms the parameters of a user's search by adding and/or subtracting search components and creating and applying filters. This transformation may take place manually by humans, automatically by software, or via a combination of both, as will be described throughout this disclosure. When the natural language request is generated by the requester and submitted to the system, the system maps the information provided in the request, along with the user's account criteria, to their account profile, which may include information about their authority to place the request, as well as business rules that need to be applied in the output.

### Intelligent Query Building

FIG. 2 shows an overview of the intelligent query building process and is a logical block diagram depicting aspects of the system. The intelligent query building process may also be referred to as a “customized” query building process. The logical blocks diagram should not be construed as a hardware diagram, and may be implemented by software, hardware, humans, or a combination of some or each. First a natural language request may be entered through a natural language input interface 210, which may be a text-fillable field on a computing device. Then, the system builds a customized query at a customized query component 220 based on some or all of the following inputs via each of the components. Final queries may be Boolean search commands that are thousands of characters long, which have exclusions, code, and other components for accessing particular databases and data platforms. The system then builds each customized query through the use of some or all of the following components. A Boolean search component 221 may automatically construct a Boolean search query from the natural language terms entered by the user. A Target Entity component 222 may look for instances within a text of “target entities,” which may comprise individuals, companies, places, organization, cities, dates, product terminologies, or other nouns that represent a focal point of the natural language request. A natural language request may contain more than one identified target entity. In such an instance, the query searches all named target entities in parallel. Then, a missing context component 222 may add search terms or other components to the Boolean search string to include search results that do not exist in the user's natural language request, which would produce a more complete and accurate result. This may be done by a human operator or by software, and in particular, may be done by machine-learning software that adds missing content based on prior inputted terms in similar searches. It is contemplated that several of the steps within the platform that may be implemented by humans and/or software may also be implemented by machine-learning programs that have been trained by large sets of human inputs over time.

A data source component 224 may add or exclude certain types of data based on the platform, site, or location where the data originates. A language component 225 may add or exclude text written in certain languages from the query.

The customized query may continue to be built using the related content component 226, which may add terms relevant to the user's organization (e.g., the company name AND competitor name(s)), and the customer relevancy component 227, which may add terms relevant to the user's position (e.g., “earnings” “sales” and “market share” for a CFO, or “broken,” “not working,” and “battery life” for a Head of Engineering).

A prior relevancy component 228 may add terms related to past similar results of interest to the particular user or topic. Such prior relevancy results may be implemented by machine-learning software that has been trained by large data sets. An exclusions component 229 may remove certain results, such as results from websites that offer products for sale, results that are near negating words, results outside a particular date range, foreign language results, teaser articles, sites that redirect users to fake or nefarious sites, etc. A lexical topic component 241 may refer to a set or word or phrase tables stored in the system to include search results that are focused on specific subject areas (e.g. purchase propensity, legal terms, regulatory terms, finance terms, etc.) A disambiguation component 242 may utilize publicly available knowledge graphs like Wikipedia and user profile to resolve the surface forms of detected entities in the query to a disambiguated name for more accurate search results. For example, “apple” may be interpreted as “Apple Inc.” the company for a technology executive while it may be interpreted as “apple” the fruit for an agriculture executive. An adjacency component 243 may use cooccurrence metrics from public datasets such as unsupervised web crawls to add entities and keywords that are often co-mentioned with terms in the natural language request to get a broader range of results. An associations component 244 may add new entities that are trending up in the public discourse and are related to the entities mentioned in the natural language request because they are in the same field or discipline. For example, if the searches from an automotive executive typically include companies like “Ford®”, “Honda®”, then the associations component may add “Tesla®” because it is a trending automobile brand. Lastly, the system may employ a missing items component 245 to detect if missing values would impact the accuracy or context of the output. In embodiments, some or all of the above components may be implemented to construct the customized query. It is contemplated that other types of refining components may be added to the customized query building process without departing from the scope of the present disclosure.

The customized query process then translates each of the transformations from the components into a final Boolean operator that reflects the topic of the natural language request. An aspect of the disclosure is that the queries are written in a universal format capable of searching any type of searchable textual data from multiple data sources. The final query inputs may also themselves be entered into an artificial intelligence program to train the software program to understand and improve the kinds of query parameters that should be used for particular or future natural language queries. It is contemplated that several of the steps within the platform that may be implemented by humans and/or software may also be implemented by machine-learning programs that have been trained by large sets of human inputs over time. It is known in the field of machine learning and artificial intelligence that in order to get a machine to produce human-like results, it needs an extraordinarily large number of inputs. In many fields, large gaps still exist between human intelligence and what a machine learning or AI program can produce. In the field of the present disclosure, the gap that exists between what a human can infer from a natural language query and what a machine can infer may greatly impact an intelligent query. For example, a human can ask and answer “what would a CFO want to know about the new product release that is different from what the Head of Engineering would want to know?” Therefore, it is contemplated that human query generation may supplement software-based query writing in many embodiments.

A key aspect of natural language request entry is that a user may enter a much longer, more specific question or request than would be possible to enter in a traditional search engine. These questions may be asked with such specificity that they inform the output format against the question or request. A number of inferences need to be derived from each of these questions and instructions in order to construct appropriate customized queries for the system to process. For example, a user may ask a full question such as “what is the perception of our Q3 earnings release among the financial press and analyst community?” or “we are releasing a new product in a week and details were inadvertently sent to some employees. Are there any instances where these materials are appearing in online forums, comments, or blogs?” Other types of questions may include “Inform me of instances in digital media and on TV where our striking employees are harassing customers attempting to do business with us,” or “a disgruntled senior level employee was dismissed this morning. Alert me if they post any content on public social channels or appear in industry forums or conferences,” or “are media and influencers covering and amplifying our recent announcement effectively?” As discussed, such inferences may be added by software tools for constructing queries, but in many embodiments may be added through the support of human query writers.

When a natural language request is initiated, it is inferred that the user expects to receive the result from the request in a given time frame in the future based on data currently available, at a point when a threshold of data volume or momentum is met, or at some predetermined future time and date.

### Data Ingestion

Once the final customized query input is completed, it may be run against a number of data sources. That is, the data sources are searched for content pieces relevant to the customized query. These may include data obtained by crawling individual websites, as well as other web-hosted databases. They may also include APIs to social media and other similar database platforms, APIs from web data feeds, and internally hosted or stored databases, APIs from social media platforms such as Twitter® and Facebook®, and media monitoring services. Data may include text, images, and metadata. Content data may include text and tags. Images and video may be searched if they are associated with alt-text, tags, or if their content is converted into text. For example, there are existing services that transcribe TV broadcasts into text. In some embodiments, a browser extension that searches text of a webpage may be used to collect data. An aspect of the disclosure is that the queries are written in a universal format capable of searching any type of searchable textual data. As shown, the query is run through each of these sources 231-235.

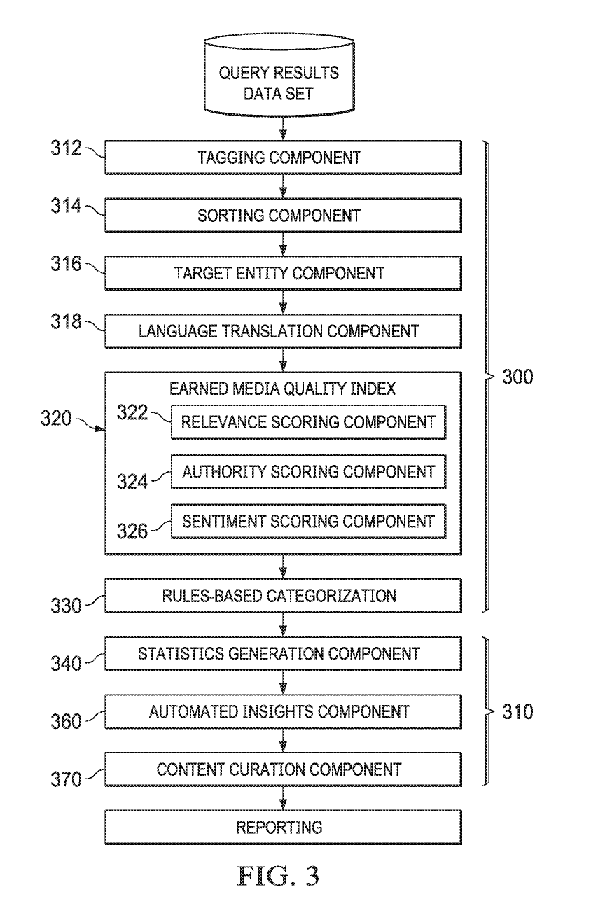

Once the customized query is run, the system produces a query results data set 240 comprising all the initial results, which becomes the “observable universe” of data related to the query against the natural language search and its enhancements. A number of additional steps may be implemented to transform the query results data set, which may be thousands or millions of pieces of content, into a useable format that is responsive to the natural language request and its enhancements. The query results data set may be referred to as “noisy,” meaning that it comprises a large amount of content that may be irrelevant, inaccurate, manipulated, or may require a high degree of analysis to determine what is most critical to the question or request. Generally, the system will attempt to ingest the full text of different content treated in different ways based on Terms of Service and licensing from each data source. The next several steps of the system of the present disclosure may be broadly referred to as the “data processing and analysis” portion of the system, which may comprise each of the following aspects:
Tagging and enrichment of data
Language translation
Rules-based categorization
Automated sentiment scoring
Automated statistics generation
Automated insights
Human and/or automated content curation
   Each of the data processing and analysis components will be described in further detail with reference to FIG. 3.

### Data Processing

In contrast to a search engine or a mention service, the system of the present disclosure takes the customer relevancy input and alters the search parameters, as previously described in the intelligent customized query building process above. For example, a natural language request containing the product name “NewPhone 3000” in a search engine would return the URLs with the most SEO (search engine optimization) value. A number of qualities and features of web pages affect SEO rankings, including, but not limited to, the URL name, number of times a word appears in a page, metadata, tags, popularity of the page, external links, etc. Search engines have their own developed criteria and algorithms for determining what information will be the most relevant to people searching particular terms, and many website owners implement sophisticated strategies for ensuring that their sites conform to those criteria and algorithms and consequently appear at the top of those results. Therefore, in response to a search engine query such as “how is the NewPhone 3000 being received in the marketplace?” by the CFO of the Company A, the Head of Engineering at Company A, and the CEO of Company B, the search engine results are likely to be the same: top tech review sites, press releases, and publicly available sales and financial information may appear to each of these users, largely defined by the sophistication of SEO techniques employed by the website publisher.

What often will not appear in these search engine results are social media posts, small blog mentions, or less sophisticated SEO-optimized sites, which can offer more in-depth insight to a topic or event that is timelier or more relevant than information presented on mainstream media outlets. Historically, users could use a mentions service to track, for example, new mentions of “NewPhone 3000.” These searches can produce millions of results. These services may have some ability to filter content to sort results into certain categories. If the topic is important enough to an organization, the organization may devote sufficient time and energy or technical analysts to data-mine the information. However, dedicating such resources can be costly, time consuming, biased, and inaccurate. As a result, many critical organizational intelligence questions go unanswered. In short, search results from search engines are often too generalized, manipulated, and noisy. Both kinds of search often miss the “answer” to a user's actual question, or miss insights that would be valuable to the user. The present system addresses each of these problems.

The data processing 300 of the platform applies several transformations to the content gathered through the query results data set. The data processing portion 300 of the platform uses machine learning and natural language processing, in addition to applying several filters and transformations to the content gathered via the query results data set. As an initial part of the data processing system 300 the content may be tagged at tagging component 312 and then sorted according to tags at sorting component 314. The term “tag” may be used throughout this disclosure to refer to a metadata object added to a piece of data or piece of content, or any other type of identifying data within a piece of data or piece of content. The tagging component 312 may automatically detect existing tags within content, such as keywords within text, HTML code in web pages, file names, alt-text, etc. Additionally, or alternatively, new, customized tags may be added by the tagging component automatically or manually. This may be advantageous when the system or a curator thereof wishes to create specialized tags to sort certain content into a customized category. It may also assist in the automatic gathering of content via the tag via a third-party platform (e.g., in the way hashtags on social media can be automatically gathered). This tagging component may be used, for example, to allow an analyst to manually tag a piece of content that is found online during some point in a query process. In some embodiments, the tagging component may be implemented via a browser extension. In some embodiments, all or part of a query may be re-run to include such specially-tagged content in the query data set 340. The sorting component 314 organizes each piece of content according to the tags.

The system may examine the text to determine the presence, volume and location of the Target Entity or Entities located throughout the text via a target entity component 316

Additional aspects of the data processing portion 300 of the platform may be implemented to derive contextual information. The language translation component 318 may translate foreign language content into the search language utilized in the natural language search request. The language translation component 318 may be implemented in multiple parts of the platform. For example, it may be implemented before tagging and sorting content when a search term pulls up a piece of content in a foreign language. The language translation may be implemented by a software program. When the piece of content is translated, it may reveal more terms that were included in the original query, and as a result, may be tagged and sorted. Alternatively, it may be implemented after tagging and sorting, so that only certain content is translated. This may be advantageous when the volume of foreign-language content is so great that translation of each piece of content would be too time-consuming.

Several of the following “scoring” components described in this and subsequent paragraphs may comprise a composite measure referred to herein as an Earned Media Quality Index (EMQI) 320. The EMQI may be thought of as a multi-dimensional weighting algorithm for quality of a media source. A first component of the EMQI may include a Relevance scoring component 322. The relevance scoring component 322 may be used to measure the degree to which the texts generated through the query are categorically material to the Target Entity or Entities identified in the natural language request, and assign a numerical value that ranks content across all previously processed content for that Target Entity. To determine which are most categorically material, the system may comprise one or more algorithms for weighting the importance of each piece of content as it relates to the target entity. For example, if Company A is mentioned in the title of a story in a popular publication, as well as ten instances within the text of a 500-word article with a unique distribution or concentration pattern, it could earn a higher score than if Company A is also mentioned in the title of a story, also in a popular publication, but with five mentions concentrated in a lower percentile of a 1,000 word article.

An authority scoring component 324 may be used to measure the degree at which the texts generated by the query have a greater level of influence, better reputation, or credibility when compared against other similar texts. Generally, news articles, websites, and social media posts that are presumed to have a larger audience are considered more authoritative. However, this is not always the case. Authority scoring may be a numerical value that ranks content within internet publications according to popularity of the source, volume, distribution and concentration of target entity mentions within the story, placement of the story, SEO value, and other indicators that a particular story or publication is more important than others. To determine which texts are the most categorically authoritative, the system may comprise one or more algorithms, which may use one or more of the following criteria as inputs: source or author of content, number of total similar results, most commonly returned words or phrases, length of content pieces, total impressions by content piece, and demographic information of content creators.

Another aspect of the EMQI 320 of the platform is a sentiment scoring component 326. Sentiment scoring may be used to determine the tone of each text specifically as it relates to the target entity identified in the natural language query. The system of the scores sentiment of the text dependent on the intensity of positive, negative, or negative words or phrases in the proximity of the target entity. This enables one piece of content to have multiple sentiment scores, depending on the target entity and the phrases used in proximity of the target entity. Sentiment tagging may be automatically completed by the system, by humans for input into an artificial intelligence database for training, or via a combination of both automated and manual tagging.

### Static or Dynamic Rules Application

The data processing portion 300 may further comprise a rules-based categorization component 330, which may be used to rank the sorted content in terms of a number of different metrics. The rules-based categorization component 330 may comprise several if/then rules. These rules may affect a variety of characteristics of a piece of content. The following are just a few examples of types of rules that may be implemented to rank sorted content. Example rules may include “If the Wall Street Journal® posts an article about ABC Phone company, then put it before all articles from other sources,” “if a media object includes a swear word, replace it with ****,” and “if an article mentions the word ‘drone,’ tag it with ‘Aerospace’ and ‘consumer electronics.’” These rules-based categorization methods may provide the benefit of providing sorted, categorized, and ranked content that is highly responsive to the original query.

As described earlier in the disclosure, users of the system may be set up with accounts which identify their organization and position within the organization. The system uses this information to create a dynamic rule that may be referred to as a “customer relevancy filter.” This dynamic customer relevancy rule may change the ranking and sorting of content significantly. For example, if the Chief Financial Officer for Company A asks about how Company A's new product is being received, and the Head of Engineering from Company A asks the same question, the results that will be important to each of those individuals will be different. The difference in the points of view between positions at the same company distinguishes what will be relevant. Similarly, if the CEO of Company B, a competitor of Company A, asks how Company A's product is being received, an additional distinction exists: what is good news to Company A may be bad news to Company B.

It is contemplated that the steps of the data processing portion 300 may take place in different orders that shown and described without departing from the scope of the disclosure.

### Analysis

The system may further comprise an analysis portion 310 may further comprise a statistics generation component 340 to provide further context to the output that will subsequently be delivered to a report recipient. Numerical statistics may be collected and compiled in a database in the system, and may include statistics related to the total universe of content within the results data set, subsets of content within the results data set, or may rely on the application of other algorithms. In many embodiments, these statistics will be generated automatically when data is processed through the analysis component of the platform. In some embodiments, the statistics may be personalized to particular users or clients based on the users' key performance indicators (KPIs). Such KPIs may be selectable by a user and may be automatically adjusted based on users' actions over time, such as clicking on a particular statistic in a link or e-mail. Systems and methods for displaying these statistics will be discussed later in the disclosure.

The analysis portion 310 may further comprise an insights component 360, which may be automated in some embodiments. The term “insights” may refer to human-readable reports or summaries based on the statistics and/or rules-based categorization. Certain insights may be automated according to formulas. For example, statements indicating how a numerical trend may be interpreted may automatically be generated, such as “the number of tweets about his topic has declined from 1,000 to 12 in the last seven days, indicating that the topic is no longer trending.” These automatically generated insights may be supplemented by human report writing, which may put the categorization and statistics into a format that answers the user's original natural language request.

Another aspect of the analysis portion 310 may include a content curation component 370. As a result of the steps of the system described up to this point, content pieces, as well as statistics, insights, and other information about those content pieces, may be available to deliver to a report recipient in one or more output formats. The content curation component may comprise machine or human editorial review to ensure that the content pieces and the information about them that will be delivered are indeed responsive to the original natural language request and relevant for the particular report recipient. In this curation step, the machine or human may consider any of the factors described within this disclosure, or any other factors, to edit, adjust, re-rank, or otherwise alter the output format.

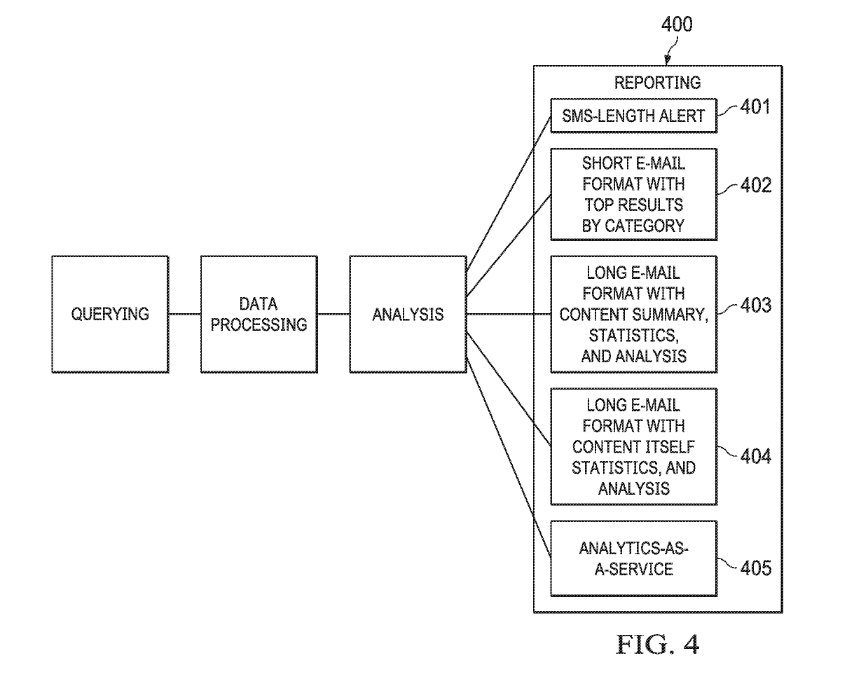

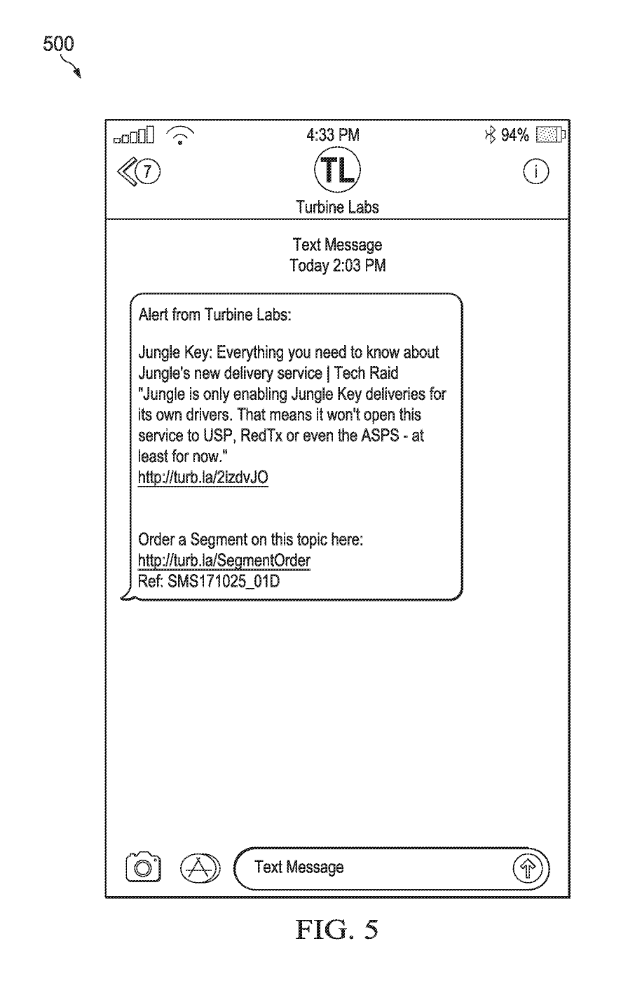

In sum, the analysis portion 310 of the platform transforms the query results to find the most impactful, relevant information. The scope of search and analysis that may be performed is vast and comprehensive, but may be most valuable to a user in different formats at different times. FIG. 4 is a logical block diagram illustrating aspects of the reporting portion 400 of the platform in further detail. FIGS. 5-8 show exemplary embodiments of the reporting outputs 401-405 in FIG. 4. Reference may be made to multiple figures simultaneously to describe the features of each reporting output.

### Distribution and Routing

One exemplary reporting format is an SMS-length alert implemented in a product called “Cue”. The product names of the various reporting formats are exemplary only and not limited to the descriptions and depictions herein. FIG. 5 shows a Cue SMS message 500 that a user may receive. The user may request this type of reporting output when entering the natural language request. This text message reporting output may be sent when a user or group of users require an immediate notification whenever a particular type of content appears online or when a predetermined or dynamic threshold is met. For example, if a particular product, company, or event meets a momentum or clustering threshold, or if an article about that topic meets or exceeds a certain Earned Media Quality Index score, the reporting portion may generate a text message with links to the content and/or additional reporting outlets.

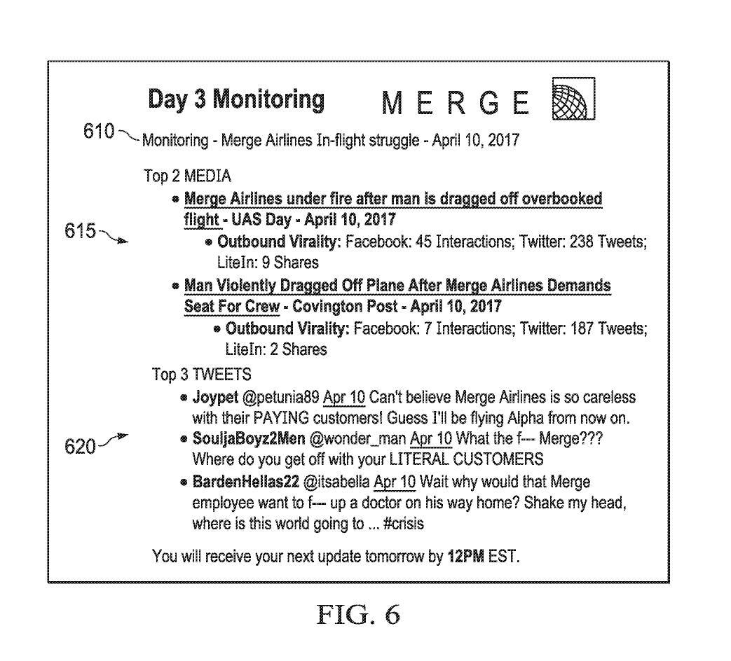

Another type of reporting format shown in FIG. 6 is a short email format 600 showing a condensed number of results based on category, threshold, or other metric. This may be implemented in a product called “Tabs.” The short email may show links and content snippets based on the natural language search criteria. This reporting output format is longer than the text message output shown in FIG. 5, and allows the user to access multiple pieces of content.

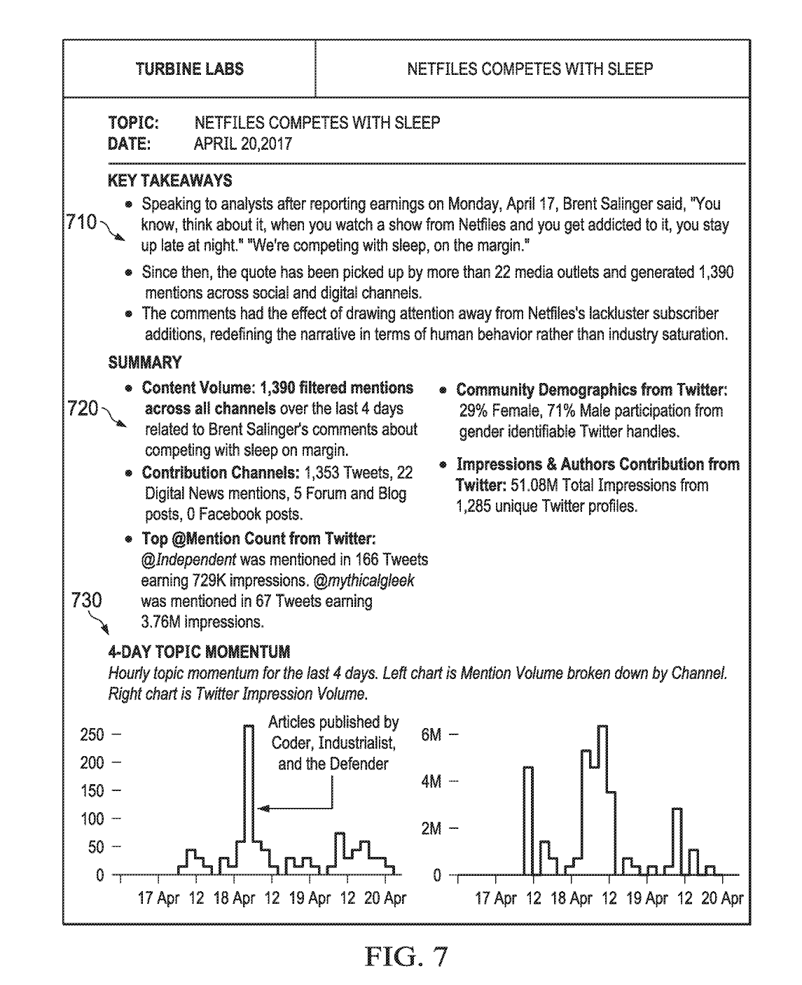

Another reporting format, shown in FIG. 7, is a longer form output 700 with an executive summary, statistics, analysis as an email or other type of electronic document or web page. This may be implemented in a product called “Segment.” This output format may also be useful over a defined period of time, such as several days or weeks, and may be delivered several times. In other scenarios, it may be required only once, shortly after a particular event.

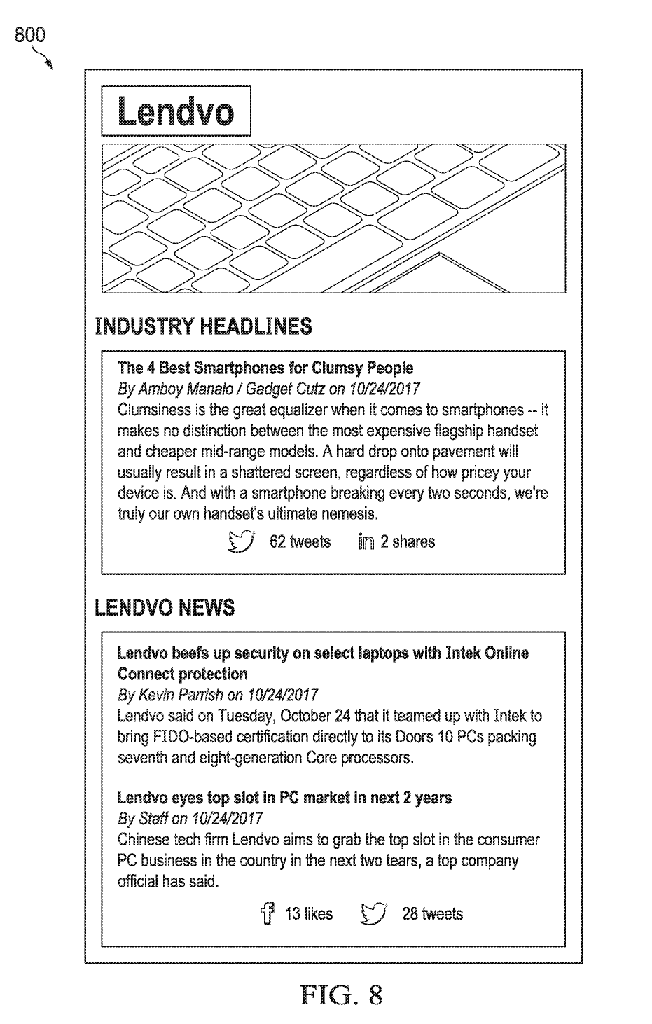

Yet another reporting output is another long e-mail format with content itself, statistics, and analysis 404, which is shown in FIG. 8 as a summary e-mail 800. There may be several differences between the long e-mail format 700 known as a Segment and the long e-mail format 800, which may be known as a product called “Digest.” The Digest may be sent periodically at predetermined intervals and include information that is broader and less time-sensitive than that in the other products. The search queries that may be best suited for this output format may be broadly about industry or product news; a report recipient may request such a Digest to create a sort of newsletter that is responsive to their particular inquiry.

Each of the various reporting outputs are highly customized to each report recipient based on the systems and processes described above, and may be further personalized over time as users respond and interact with the output formats they receive. It is contemplated that each of the output formats may contain measurable feedback mechanisms that indicate a user's level of interest in a particular topic. For example, each output format may include one or more links to a piece of content, and each user's level of engagement with each link (i.e., clicks, views, length of time spent with linked content) may be measured and sent back to the platform to indicate that the user prefers to see content with similar attributes. A user's preference may be classified by several attributes of the content. For example, if a user engages with a particular source of content, such as tweets or Facebook posts, or a particular media format, such as videos or written texts, or a particular topic, such as marketing or public relations, an algorithm of the platform may prioritize that type of preferred content in that user's output format in the future.

Another reporting output may include an analytics-as-a-service dashboard display. Analytics-as-a-service allows users to select and access graphical displays of pertinent information without having to set up an analytics-capable network infrastructure. Certain companies may not wish to set up their own analytics systems because they can be resource-intensive. Embodiments of the present disclosure may make any of the results generated from the filtered search and analysis portions of the platform available through a cloud-based service.

Analytics-as-a-service may also be implemented as an automated statistics gathering service using a user or client's own data. For example, clients may be able to provide gathered data of any sort, such as in a spreadsheet, customer relationship management (CRM) database, or other enterprise software database, and have statistics automatically generated from it. These automatic statistics may be generated from applying the client's data to the filtered search and analysis components of the system. For example, the system may take a client's spreadsheet of links, tags, customer names, and derive any number of statistics from that data set. The derived statistics may include, for example, the web traffic associated with each of the links, or the number of customers on the list that follow the client's company on social media. It is contemplated that any metric searchable through the system of the present disclosure may be a source of statistics from client-provided data. The analytics-as-a-service output 405 may include such reports about automatically gathered statistics.

It is contemplated that each of the reporting outputs 401-405 may be generated using all or part of the filtered search and analysis portions of the platform. In other words, the entire system may be implemented even when the output shows only a small portion of the content that was searched and analyzed. The platform of the present disclosure thereby utilizes robust human and/or software/machine-learning processes to deliver finely curated content from the vast expanse of the internet.

Yet another aspect of the disclosure is that the query, data processing and analysis, and output system may serve one or more external APIs to provide all or part of the data gathered and sorted to another application. For example, some enterprise software applications may desire a third-party integration of the data that is collected and sorted through the unique methods of the present system. It can be useful for companies with software deployed in many geographic locations to have certain types of trending or queried data (the type that may be gathered by natural language queries of the platform) specifically routed to certain types of employees based on defined criteria (e.g., employee type or geographic location). As just one example, enterprise software that controls airline schedules may integrate data from the present platform via an API to monitor consumer social media engagement in the immediate wake of flight delays or cancellations. Natural language queries such as “how are travelers in Chicago reacting to delays of the following flights?” could be asked via the platform or a third-party integration interface to the platform, and the results could be delivered to gate agents in Chicago. As another example, an insurance company could use the natural language query to ask “how bad is the hailstorm in Colorado” and based on the results, could determine what level of staff resources to deploy in a short period of time. The above examples are just two of the many ways API integrations of the platform may be used advantageously. It is contemplated that varying amounts and kinds of data may be made available through the one or more APIs of the present system.

### Personalization

A personalization aspect of the disclosure may comprise automatic enhancements as a result of particular user actions over time. In other words, because the natural language request is associated with requester and other attributes (role within organization, etc.), those attributes may become more finely tuned over time through machine learning. For example, Bob, who is VP of Investor Relations, asks a question about Company A financial performance. Over time, system will infer interest in financial topics based on Bob continually asking finance related questions, and interacting with finance-related content, and may include more stories about finance in future reports. Mary, who is Chief Marketing Officer, asks a question about Company A financial performance. Over time, the system will infer interest in brand or reputation topics based on Mary's role as CMO, the questions she has asked previously, and brand-related content she has interacted with previously.

### License Payments

Yet another aspect of the disclosure provides systems and methods to enable report recipients to easily and conveniently access content delivered through one or more of the reports. Often, content that is retrieved and ultimately delivered to report recipients is from news media sources which charge subscription service fees for accessing digital content. Such content is often referred to as “paywalled” in the digital media and publishing industry. Because the reports of the present disclosure are designed to deliver highly relevant content to the report recipient, it is likely that the recipient will click on links to articles included in the report. If such articles are paywalled by the publisher and the recipient does not have a subscription, the recipient may not have access to the article, or at the very least will be delayed or inconvenienced by having to subscribe to the publication before continuing to read the article.

In the system of the present disclosure, linked, paywalled content in delivered reports may be hosted within the databases of the system so that report recipients can click on the links and read the content even if they do not have a subscription to the paywalled source. The paywalled content may be hosted on an intranet or any other kind of accessible database for serving content. In order to ensure that the publisher or content creator are compensated for paywalled content, a payment may be made to the news media source when a paywalled article is accessed on the system. This payment may be made by the entity hosting the content and/or providing the system of the disclosure. The payment may be pro-rated and/or less than the cost of a subscription to the whole news media source. A benefit to the report recipient is that there is no upfront cost or time delay in accessing a paywalled article. A benefit to the news media source is that they may derive revenue and readership from a non-subscriber who may have otherwise opted to not read the article at all. With high volumes of highly relevant, precisely targeted paywalled content being delivered to report recipients, the amount of revenue that may be generated for the news media sources may be significant.

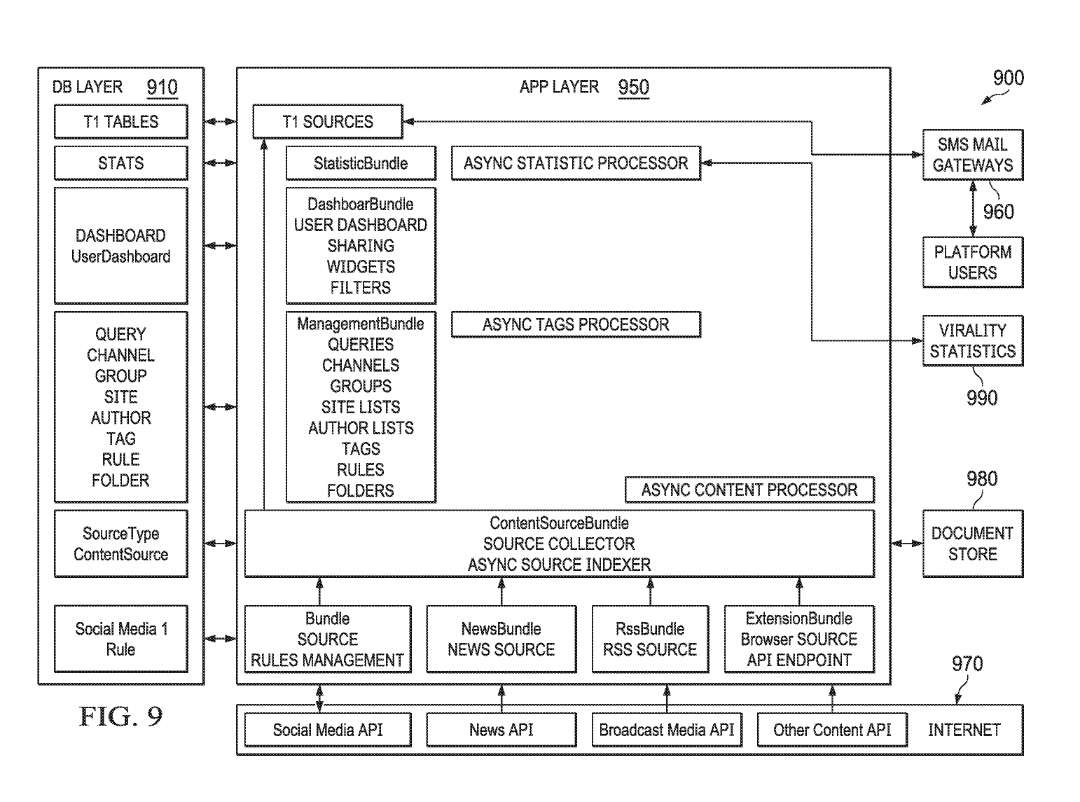

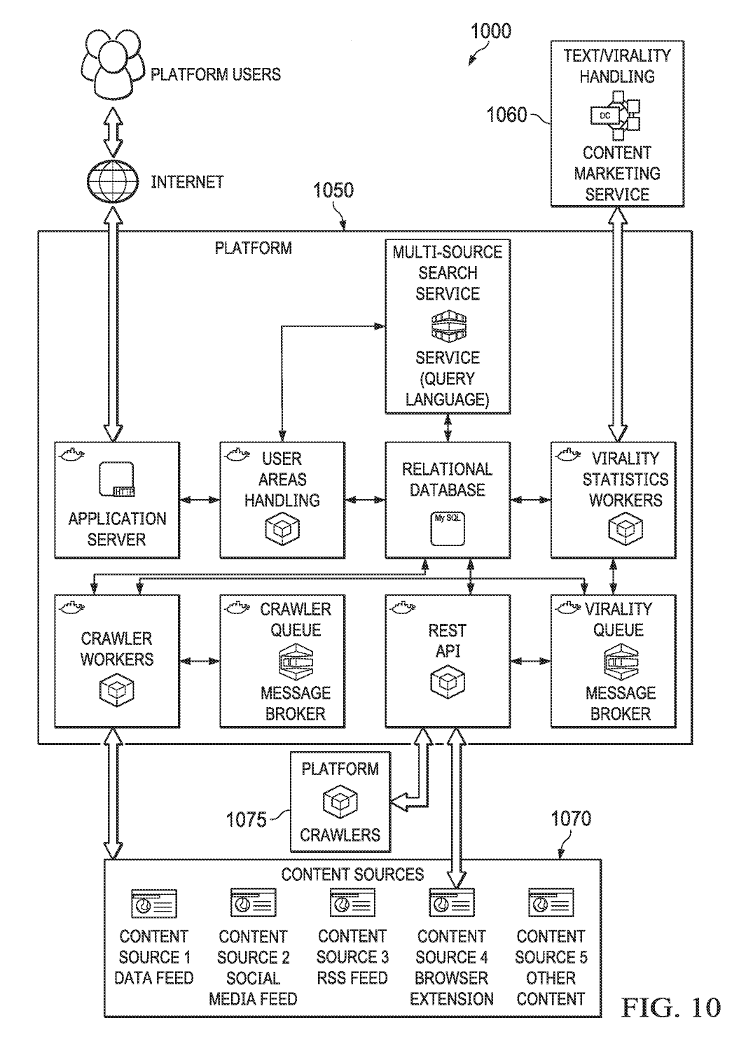

Turning next to FIGS. 9 and 10, shown are two exemplary versions of database, application, and/or network architectures 900 and 1000 that may be used to implement aspects of the disclosure described in previous FIGS. 1-8. The architectures 900 and 1000 may comprise all or some of the logical blocks shown, and in other embodiments may comprise additional logical or functional blocks. The architectures 900 and 1000 as shown may implement particular brand-name services, feeds, databases, and tools, but these are exemplary only, and other suitable tools may be substituted without departing from the scope of the present disclosure.

FIG. 9 shows a database layer 910 that stores data for and provides data to an application layer 950. Application layer 950 interfaces with content and data sources 970, which may comprise several different internet sources as shown. The application layer 950 may further interface with SMS mail gateways 960 in order to reach platform users via the SMS-based output reports described in this disclosure. The application layer may further interface with a document store 980 and a virality statistics service 990.

FIG. 10 shows a similar but alternative network architecture depicting an integrated platform 1050 comprising databases and application components. In embodiments, the platform 1050 may be hosted on a cloud server. As shown, the platform 1050 may interface with external content and data sources 1070 and platform crawlers 1075. The platform may also interface with several external services, which may comprise SMS service, document stores, virality statistics services, and other similar services.

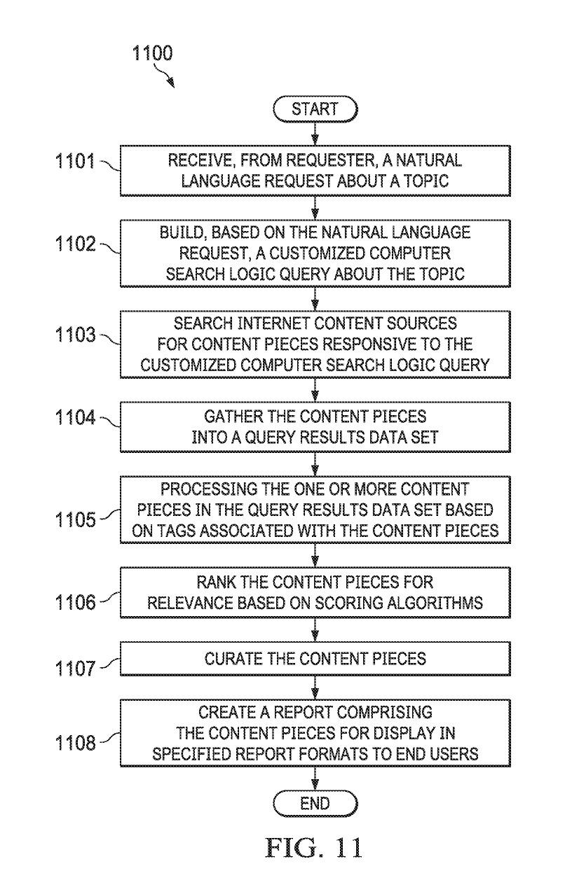

FIG. 11 is a flowchart depicting a method 1100 for internet content collection, and the curation and delivery thereof, according to the present disclosure. The method may include, at step 1101 receiving, from a requester, a natural language request about a topic and building, at step 1102 based on the natural language request, a customized computer search logic query about the topic. The method may then comprise, at step 1103, searching one or more internet content sources for one or more content pieces responsive to the customized computer search logic query, and gathering, at step 1104, the one or more content pieces into a query results data set. The system may further comprise, at step 1105, processing the one or more content pieces in the query results data set based on one or more attributes associated with the content pieces, ranking, at step 106, the content pieces for relevance based on one or more scoring algorithms, curating, at step 1107, the content pieces, and creating a report, at step 1108, comprising the content pieces for display in one or more specified report formats to one or more report recipients.

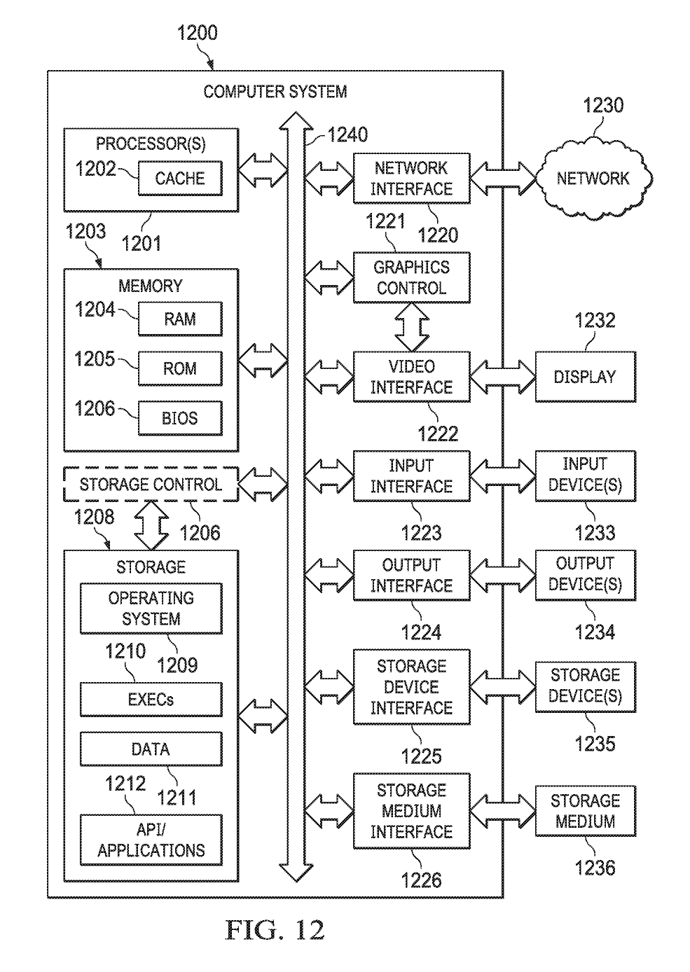

Referring next to FIG. 12, it is a block diagram depicting an exemplary machine that includes a computer system 1200 within which a set of instructions can execute for causing a device to perform or execute any one or more of the aspects and/or methodologies of the present disclosure. The components in FIG. 12 are examples only and do not limit the scope of use or functionality of any hardware, software, embedded logic component, or a combination of two or more such components implementing particular embodiments.

Computer system 1200 may include a processor 1201, a memory 1203, and a storage 1208 that communicate with each other, and with other components, via a bus 1240. The bus 1240 may also link a display 1232, one or more input devices 1233 (which may, for example, include a keypad, a keyboard, a mouse, a stylus, etc.), one or more output devices 1234, one or more storage devices 1235, and various tangible storage media 1236. All of these elements may interface directly or via one or more interfaces or adaptors to the bus 1240. For instance, the various tangible storage media 1236 can interface with the bus 1240 via storage medium interface 1226. Computer system 1200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1201 (or central processing unit(s) (CPU(s))) optionally contains a cache memory unit 1202 for temporary local storage of instructions, data, or computer addresses. Processor(s) 1201 are configured to assist in execution of computer readable instructions. Processor(s) 1201 may include one or more graphics processing units (GPU(s)). In some embodiments, the GPU may be used to execute machine learning AI (artificial intelligence) programs. Computer system 1200 may provide functionality for the components depicted in FIGS. 1-4 and 9-10 as a result of the processor(s) 1201 executing non-transitory, processor-executable instructions embodied in one or more tangible computer-readable storage media, such as memory 1203, storage 1208, storage devices 1235, and/or storage medium 1236. The computer-readable media may store software that implements particular embodiments, and processor(s) 1201 may execute the software. Memory 1203 may read the software from one or more other computer-readable media (such as mass storage device(s) 1235, 1236) or from one or more other sources through a suitable interface, such as network interface 1220. The software may cause processor(s) 1201 to carry out one or more processes or one or more steps of one or more processes described or illustrated herein. Carrying out such processes or steps may include defining data structures stored in memory 1203 and modifying the data structures as directed by the software.

The memory 1203 may include various components (e.g., machine readable media) including, but not limited to, a random access memory component (e.g., RAM 1204) (e.g., a static RAM “SRAM”, a dynamic RAM “DRAM, etc.), a read-only component (e.g., ROM 1205), and any combinations thereof. ROM 1205 may act to communicate data and instructions unidirectionally to processor(s) 1201, and RAM 1204 may act to communicate data and instructions bidirectionally with processor(s) 1201. ROM 1205 and RAM 1204 may include any suitable tangible computer-readable media described below. In one example, a basic input/output system 1206 (BIOS), including basic routines that help to transfer information between elements within computer system 1200, such as during start-up, may be stored in the memory 1203.

Fixed storage 1208 is connected bidirectionally to processor(s) 1201, optionally through storage control unit 1207. Fixed storage 1208 provides additional data storage capacity and may also include any suitable tangible computer-readable media described herein. Storage 1208 may be used to store operating system 1209, EXECs 1210 (executables), data 1211, API applications 1212 (application programs), and the like. Often, although not always, storage 1208 is a secondary storage medium (such as a hard disk) that is slower than primary storage (e.g., memory 1203). Storage 1208 can also include an optical disk drive, a solid-state memory device (e.g., flash-based systems), or a combination of any of the above. Information in storage 1208 may, in appropriate cases, be incorporated as virtual memory in memory 1203.

In one example, storage device(s) 1235 may be removably interfaced with computer system 1200 (e.g., via an external port connector (not shown)) via a storage device interface 1225. Particularly, storage device(s) 1235 and an associated machine-readable medium may provide nonvolatile and/or volatile storage of machine-readable instructions, data structures, program modules, and/or other data for the computer system 1200. In one example, software may reside, completely or partially, within a machine-readable medium on storage device(s) 1235. In another example, software may reside, completely or partially, within processor(s) 1201.

Bus 1240 connects a wide variety of subsystems. Herein, reference to a bus may encompass one or more digital signal lines serving a common function, where appropriate. Bus 1240 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1200 may also include an input device 1233. In one example, a user of computer system 1200 may enter commands and/or other information into computer system 1200 via input device(s) 1233. Examples of an input device(s) 1233 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 1233 may be interfaced to bus 1240 via any of a variety of input interfaces 1223 (e.g., input interface 1223) including, but not limited to, serial, parallel, game port, USB, FIREWIRE, THUNDERBOLT, or any combination of the above.

In particular embodiments, when computer system 1200 is connected to network 1230, computer system 1200 may communicate with other devices, specifically mobile devices and enterprise systems, connected to network 1230. Communications to and from computer system 1200 may be sent through network interface 1220. For example, network interface 1220 may receive incoming communications (such as requests or responses from other devices) in the form of one or more packets (such as Internet Protocol (IP) packets) from network 1230, and computer system 1200 may store the incoming communications in memory 1203 for processing. Computer system 1200 may similarly store outgoing communications (such as requests or responses to other devices) in the form of one or more packets in memory 1203 and communicated to network 1230 from network interface 1220. Processor(s) 1201 may access these communication packets stored in memory 1203 for processing.

Examples of the network interface 1220 include, but are not limited to, a network interface card, a modem, and any combination thereof. Examples of a network 1230 or network segment 1230 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1230, may employ a wired and/or a wireless mode of communication. In general, any network topology may be used.

Information and data can be displayed through a display 1232. Examples of a display 1232 include, but are not limited to, a liquid crystal display (LCD), an organic liquid crystal display (OLED), a cathode ray tube (CRT), a plasma display, and any combinations thereof. The display 1232 can interface to the processor(s) 1201, memory 1203, and fixed storage 1208, as well as other devices, such as input device(s) 1233, via the bus 1240. The display 1232 is linked to the bus 1240 via a video interface 1222, and transport of data between the display 1232 and the bus 1240 can be controlled via the graphics control 1221.

In addition to a display 1232, computer system 1200 may include one or more other peripheral output devices 1234 including, but not limited to, an audio speaker, a printer, and any combinations thereof. Such peripheral output devices may be connected to the bus 1240 via an output interface 1224. Examples of an output interface 1224 include, but are not limited to, a serial port, a parallel connection, a USB port, a FIREWIRE port, a THUNDERBOLT port, and any combinations thereof.

In addition, or as an alternative, computer system 1200 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for internet content collection and the curation and delivery thereof; the method comprising:
receiving, from a requester, a natural language request about a topic;
building, based on the natural language request, a customized computer search logic query about the topic;
searching, via the customized computer search logic query, one or more internet content sources for one or more content pieces responsive to the customized computer search logic query;
gathering the one or more content pieces into a query results data set;
processing the one or more content pieces in the query results data set based on one or more attributes associated with the content pieces;
ranking the one or more content pieces based on one or more scoring algorithms;
curating the one or more content pieces by reviewing the one or more content pieces for responsiveness to the natural language request;
creating a report comprising the content pieces for display in one or more specified report formats to one or more report recipients.

2. The method of claim 1, wherein the one or more content pieces comprise each of:
content from one or more social media posts; and
content from one or more news articles.

3. The method of claim 1, wherein the customized computer search logic query is built at least in part by a human query writer.

4. The method of claim 1, wherein the requester is a human.

5. The method of claim 1, wherein the attributes comprise one or more of:
tags,
languages; and
a presence of one or more terms referring to a target entity.

6. The method of claim 1, further comprising:
adding one or more tags to the one or more pieces of content.

7. The method of claim 6, wherein the adding is done automatically by a tagging program.

8. The method of claim 1, wherein the one or more scoring algorithms comprise each of:
relevance scoring;
authority scoring; and
sentiment scoring.

9. The method of claim 8, wherein the ranking is further based on one or more of:
source or length of a particular content piece;
number of total similar results; or
number of total similar results.

10. The method of claim 1, wherein the one or more specified report formats comprises an SMS text message.

11. The method of claim 1, further comprising:
performing one or more analyses on the one or more content pieces, wherein the one or more analysis comprises one or more of:
generating statistics about the one or more content pieces; and
generating one or more insights in the form of a written text summary.

12. The method of claim 1, wherein the curating is performed by a human.

13. The method of claim 1, further comprising:
receiving one or more indications from the one or more report recipients of engagement with one or more particular content pieces from the report;
using the one or more indications in a subsequent ranking for relevance in a subsequent report; and
delivering the subsequent report to the one or more report recipients from which the one or more indications were received.

14. The method of claim 13, wherein the one or more indications are used as inputs to an artificial intelligence program, and further comprising:
automatically personalizing additional subsequent reports via the artificial intelligence program.

15. The method of claim 1, further comprising:
providing, via a cloud-based service, the report via one or more graphical analytics displays.

16. The method of claim 1, further comprising:
collecting, from an entity associated with the one or more end users, one or more data sets; and
using the one or more data sets to perform the one or more analyses.

17. The method of claim 1, further comprising:
serving one or more application program interfaces to access the one or more content pieces.

18. The method of claim 1, further comprising:
analyzing the one or more content pieces; and
providing one or more pieces of additional information about the one or more content pieces in the report.

19. A platform for internet content collection and the curation and delivery thereof; the platform configured to:
receive, from a requester via a computing device, a natural language request about a topic;
build, based on the natural language request, a customized computer search logic query about the topic;
run a search via a plurality of internet data and content sources for one or more content pieces responsive to the customized computer search logic query;
gather the one or more content pieces into a query results data set in a database associated with the platform;
process, via an application associated with the platform, the one or more content pieces in the query results data set based on one or more attributes associated with the content pieces;
rank the content pieces for relevance based on one or more scoring algorithms;
curate the content pieces;
create a report comprising the content pieces in one or more specified report formats to one or more report recipients for display on a graphical user interface remote from the platform.

20. The platform of claim 19, wherein the platform is further configured to send the report via an SMS messaging service.

21. The platform of claim 1, wherein the platform is further configured to send the report via e-mail.

22. The platform of claim 19, wherein the computing device for receiving the natural language request is a voice-response enabled computing device.

23. The platform of claim 19, wherein the plurality of internet data content sources comprise each of:
a social media application program interface;
a news data feed;
an RSS feed;
and a browser extension.

24. The platform of claim 19, wherein the platform is configured to allow a human to curate the one or more content pieces.
